(19) United States
(12) Patent Application Publication
(10) Pub. No.: US 2025/0167913 A1
(43) Pub. Date: May 22, 2025

(54) APPARATUS AND METHOD FOR TRANSMITTING/RECEIVING INFORMATION USING WIRELESS COVERT CHANNEL

(71) Applicant: ELECTRONICS AND TELECOMMUNICATIONS RESEARCH INSTITUTE, Daejeon (KR)

(72) Inventors: Yong-Sung JEON, Daejeon (KR); Sang-Woo Lee, Daejeon (KR); Ha-young Seong, Daejeon (KR); Dong-Ho Kang, Daejeon (KR)

(73) Assignee: ELECTRONICS AND TELECOMMUNICATIONS RESEARCH INSTITUTE, Daejeon (KR)

(21) Appl. No.: 18/765,595

(22) Filed: Jul. 8, 2024

(30) Foreign Application Priority Data
Nov. 20, 2023 (KR) 10-2023-0160661

(51) Int. Cl. H04L 1/00; H04W 12/03

(52) U.S. Cl. CPC H04L 1/0007; H04L 1/0061; H04W 12/03

(57) ABSTRACT

Disclosed herein is an apparatus and method for transmitting/receiving information using a wireless covert channel. The apparatus for transmitting information using a wireless covert channel includes memory in which at least one program is recorded and a processor for executing the program. The program generates a packet from each of data blocks having a predetermined size acquired by dividing data and transmits the packet through a covert channel, the packet is configured with a header and a payload, and the header may include a Start Frame Delimiter (SFD) field indicating the start point of the packet, a payload attribute field indicating whether the payload is data or a Cyclic Redundancy Check (CRC), and a payload bit inversion field indicating whether the value of the payload is inverted in units of bits.

### CROSS REFERENCE TO RELATED APPLICATION

This application claims the benefit of Korean Patent Application No. 10-2023-0160661, filed Nov. 20, 2023, which is hereby incorporated by reference in its entirety into this application.

### BACKGROUND OF THE INVENTION

### 1. Technical Field

The disclosed embodiment relates to a wireless covert channel for confidentially delivering information in a wireless manner.

### 2. Description of the Related Art

When utmost security is required or when information to be delivered is highly critical, the information may be transmitted through covert channels such that only the agreed-upon sender and receiver can detect or identify the transmitted information and that ordinary users are prevented from easily identifying the transmitted information.

Among these covert channels, wireless covert channels use five wireless media, which are sound, light, heat, a magnetic field, and an electromagnetic wave, as the means for delivering information.

These wireless covert channels face two limitations in the process of generating wireless signals using system resources.

First, because information delivery using a covert channel increases system load, the signal strength of the covert channel cannot be raised above a certain level. Also, poor communication conditions or states for the covert channel may make it difficult to frequently deliver information.

These limitations particularly affect heat and a magnetic field, among the above-mentioned five wireless media.

For example, covert channels using heat face the aforementioned two limitations.

That is, in the case of the covert channels using heat, there is a risk of damaging a system due to system load increased by the generated heat. Therefore, a design method for minimizing heat generation time is required.

Also, from the perspective of communication situations for a covert channel, it is difficult to form a covert channel using heat during the daytime during which a system operates heavily. Therefore, there is a limitation that information delivery through a covert channel using heat is possible mainly late at night.

More specifically, information delivery using a convert channel is possible during the time period between midnight and 6 a.m. out of 24 hours a day. Here, considering that a packet header is additionally required for data transmission, the actual data length that can be transmitted per day is about 1 byte or 2 bytes. Therefore, a large amount of data should be transmitted in multiple segments.

As described above, because the covert channels using heat exacerbate system load and are affected by poor communication situations, a specific method for solving these problems is required.

Besides the covert channels using heat, covert channels using magnetic fields may be difficult to use for frequent information delivery due to poor communication conditions or states for the covert channels. That is, the covert channels using magnetic fields allow a limited signal transmission distance. Only when a separate magnetic field sensor is used for signal reception may covert channel signals be received at a distance of about 1 meter. However, considering the characteristics of covert channels for confidentially transmitting and receiving information, preparing a separate magnetic field sensor for receiving signals is not a good method. Alternatively, a magnetic field sensor embedded in a smartphone may be used as a reception device. When the magnetic field sensor embedded in a smartphone is used, a signal detection distance of about 10 cm is possible. A realistic scenario involves generating a covert channel signal using a magnetic field from a PC at a specific time and collecting the covert channel signal for a short period of time by placing a smartphone near the PC. By combining signals collected in this way several times, the desired information may be obtained.

As described above, it may be often difficult to deliver information depending on the characteristics of the communication medium of a covert channel or communication conditions.

### SUMMARY OF THE INVENTION

An object of the disclosed embodiment is to reduce the intensity of a signal to be transmitted through a covert channel, thereby preventing an increase in system load.

Another object of the disclosed embodiment is to minimize the frequency of generation of a signal to be transmitted through a covert channel in poor communication conditions or states.

A further object of the disclosed embodiment is to enable an agreed-upon receiver of a covert channel to easily identify a covert channel signal even when the frequency and intensity of the covert channel signal generated for delivering information are minimized.

An apparatus for transmitting information using a wireless covert channel according to an embodiment includes memory in which at least one program is recorded and a processor for executing the program. The program may generate a packet from each of data blocks having a predetermined size acquired by dividing data and transmit the packet through a covert channel, the packet may be configured with a header and a payload, and the header may include a Start Frame Delimiter (SFD) field indicating the start point of the packet, a payload attribute field indicating whether the payload is data or a Cyclic Redundancy Check (CRC), and a payload bit inversion field indicating whether the value of the payload is inverted in units of bits.

Here, the SFD field may be one bit in length, and may be set to ‘1’.

Here, the payload bit inversion field may be one bit in length. The payload bit inversion field may be set to ‘1’ when the number of ‘1’s in the bit values of the payload is equal to or greater than the number of ‘0’s therein, but may be set to ‘0’ when the number of ‘1’s in the bit values of the payload is less than the number of ‘0’s therein. When the payload bit inversion field is set to ‘1’, the bit values of the payload may be inverted.

Here, when the payload is one byte in length, the payload attribute field may be one bit in length. The payload attribute field may be set to ‘0’ when the payload is data, but may be set to ‘1’ when the payload is a CRC.

Here, when the payload is data, lower seven bits of the payload may be set to an ASCII code corresponding to a character, whereas when the payload is a CRC, the eight bits of the payload may be set to the CRC.

Here, when the payload is three bytes in length, the payload attribute field may be two bits in length. The payload attribute field may be set to ‘00’ when the payload is one-byte data, may be set to ‘01’ when the payload is two-byte data, may be set to ‘10’ when the payload is three-byte data, and may be set to ‘11’ when the payload is a CRC.

An apparatus for receiving information using a wireless covert channel according to an embodiment includes memory in which at least one program is recorded and a processor for executing the program. The program may determine a reference value for bit identification using a received signal in the section of a Start Frame Delimiter (SFD) field indicating the start point of a packet, determine bit values constituting a received packet using a received signal based on the reference value for bit identification, determine whether a payload is data or a CRC depending on the value of a payload attribute field in the determined bit values, and invert the value of the payload in units of bits depending on the value of a payload bit inversion field in the determined bit values.

Here, before determining the reference value for bit identification, the program may calculate average values for a predetermined number of previous points at each point of received raw data.

Here, when determining the reference value for bit identification, the program may calculate the maximum and minimum values of the average values of a predetermined number of received signals in the section of the SFD field and set a predetermined median value between the calculated maximum and minimum values as the reference value for bit identification.

Here, when determining the bit values, the program may determine whether bit values within a predetermined intermediate section in each bit reception period are equal to or greater than the reference value for bit identification and determine a bit value in the corresponding bit reception period to be ‘1’ or ‘0’ depending on whether the number of contiguous bit values equal to or greater than the reference value for bit identification is equal to or greater than a predetermined number.

A method for transmitting/receiving information using a wireless covert channel according to an embodiment includes dividing, by a transmission apparatus, data into data blocks having a predetermined size, generating, by the transmission apparatus, packets from the respective data blocks, and transmitting, by the transmission apparatus, the generated packets through a covert channel. The packet may be configured with a header and a payload, and the header may include a Start Frame Delimiter (SFD) field indicating the start point of the packet, a payload attribute field indicating whether the payload is data or a CRC, and a payload bit inversion field indicating whether the value of the payload is inverted in units of bits.

Here, the SFD field may be one bit in length, and may be set to ‘1’.

Here, the payload bit inversion field may be one bit in length. The payload bit inversion field may be set to ‘1’ when the number of ‘1’s in the bit values of the payload is equal to or greater than the number of ‘0’s therein, but may be set to ‘0’ when the number of ‘1’s in the bit values of the payload is less than the number of ‘0’s therein. When the payload bit inversion field is set to ‘1’, the bit values of the payload may be inverted.

Here, when the payload is one byte in length, the payload attribute field may be one bit in length. The payload attribute field may be set to ‘0’ when the payload is data, but may be set to ‘1’ when the payload is a CRC.

Here, when the payload is data, the lower seven bits of the payload may be set to an ASCII code corresponding to a character, whereas when the payload is a CRC, the eight bits of the payload may be set to the CRC.

Here, when the payload is three bytes in length, the payload attribute field may be two bits in length. The payload attribute field may be set to ‘00’ when the payload is one-byte data, may be set to ‘01’ when the payload is two-byte data, may be set to ‘10’ when the payload is three-byte data, and may be set to ‘11’ when the payload is a CRC.

Here, the method for transmitting/receiving information using a wireless covert channel according to an embodiment may further include determining, by a reception apparatus, a reference value for bit identification based on a received signal in the section of the SFD field indicating the start point of the packet, determining, by the reception apparatus, bit values constituting a received packet using a received signal based on the reference value for bit identification, determining, by the reception apparatus, whether the payload is data or a CRC depending on the value of the payload attribute field in the determined bit values, and inverting, by the reception apparatus, the value of the payload in units of bits depending on the value of the payload bit inversion field in the determined bit values.

Here, the method may further include, before determining the reference value for bit identification, calculating average values for a predetermined number of previous points at each point of received raw data.

Here, determining the reference value for bit identification may include calculating the maximum and minimum values of average values of a predetermined number of received signals in the section of the SFD field and setting a predetermined median value between the calculated maximum and minimum values as the reference value for bit identification.

Here, determining the bit values may include determining whether received signals within a predetermined intermediate section in each bit reception period are equal to or greater than the reference value for bit identification and determining a bit value in the corresponding bit reception period to be ‘1’ or ‘0’ depending on whether the number of contiguous received signals equal to or greater than the reference value for bit identification is equal to or greater than a predetermined number.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic configuration diagram of a system for transmitting/receiving information using a wireless covert channel according to an embodiment;

FIG. 2 is an exemplary view of a covert channel transmission packet structure according to an embodiment;

FIG. 3 is an exemplary view of a covert channel transmission packet structure according to another embodiment;

FIG. 4 is a flowchart for explaining a method for transmitting information using a wireless covert channel according to an embodiment;

FIG. 5 is a flowchart for explaining a packet generation step according to an embodiment;

FIG. 6 is an exemplary view for explaining a method for transmitting information using a wireless covert channel according to an embodiment;

FIG. 7 is a flowchart for explaining a method for receiving information using a wireless covert channel according to an embodiment;

FIG. 8 is a flowchart for explaining a packet configuration step according to an embodiment;

FIG. 9 is an exemplary view of a graph of a signal received using a covert channel according to an embodiment; and

FIG. 10 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

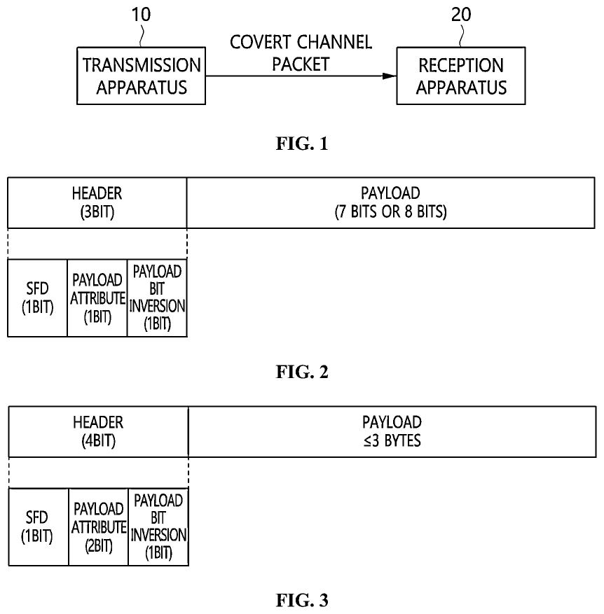

FIG. 1 is a schematic configuration diagram of a system for transmitting/receiving information using a wireless covert channel according to an embodiment, FIG. 2 is an exemplary view of a covert channel transmission packet structure according to an embodiment, and FIG. 3 is an exemplary view of a covert channel transmission packet structure according to another embodiment.

Referring to FIG. 1, the apparatus for transmitting information using a wireless covert channel and the apparatus for receiving information using a wireless covert channel according to an embodiment may generate predetermined packets from data blocks having a predetermined size, which are acquired by dividing data, and transmit/receive the generated packets through a covert channel.

Referring to FIG. 2 and FIG. 3, a packet according to an embodiment is a minimum unit for data delivery, and may be configured with a header indicating the start of the packet and a payload containing the data to be delivered.

Specifically, the header may include a Start Frame Delimiter (SFD) field, a payload attribute field, and a payload bit inversion field.

Here, the SFD field is one bit in length and is a fixed bit that is agreed upon. The SFD field may be used to indicate the start point from which the packet is transmitted. That is, communication generally requires information about the start point from which the packet is transmitted, and most communication protocols need the SFD. Therefore, the SFD having a length of one bit is defined also in a packet of a covert channel according to an embodiment, and it indicates the start of the packet. Here, the value of the SFD may be always set to ‘1’.

Here, the payload attribute field may be a field for defining the attribute of the payload to be transmitted.

Here, the payload may be a field that contains the data to be delivered or a Cyclic Redundancy Check (CRC).

The payload attribute field may have various embodiments depending on the size of the payload.

According to an embodiment, the payload may be one byte in length, that is, may have a length of 7 bits or 8 bits, as shown in FIG. 2.

Here, when the payload is data, an ASCII code corresponding to each character of the data is used, in which case only seven bits are transmitted because ASCII is able to represent each character using seven bits. That is, the Most Significant Bit (MSB) of the ASCII value is omitted, and only the lower seven bits are transmitted.

However, when the payload is a CRC, all of calculated eight bits are transmitted.

Here, the payload attribute field is one bit in length. The payload attribute field may be set to ‘0’ when the payload is data, but may be set to ‘1’ when the payload is a CRC.

According to another embodiment, the payload may be up to three bytes in length, as shown in FIG. 3.

Here, the payload attribute field may be two bits in length. That is, the payload attribute field may be set to ‘00’ when the payload is one-byte data, may be set to ‘01’ when the payload is two-byte data, may be set to ‘10’ when the payload is three-byte data, and may be set to ‘11’ when the payload is a CRC.

Meanwhile, referring to FIG. 2 and FIG. 3, the payload bit inversion field is a field for indicating whether to invert the value of the payload in units of bits, and may be one bit in length. That is, when the value of the payload bit inversion field is ‘1’, the data or CRC value to be transmitted is inverted in units of bits before being contained in the payload.

The payload bit inversion field according to an embodiment is for reducing as many ‘1’s as possible in the value of the payload. That is, when the value of the payload includes the bit value ‘1’, generating a signal causes system overload. Therefore, an excessive number of ‘1’s may lead to continuous overload and straining the system. Accordingly, in the embodiment, the separate payload bit inversion field may be defined in order to reduce the system overload as much as possible.

Specifically, when the number of ‘1’s in the bit values of the payload is equal to or greater than the number of ‘0’s therein, the payload bit inversion field may be set to ‘1’, and the bit values of the payload may be inverted.

Conversely, when the number of ‘1’s in the bit values of the payload is less than the number of ‘0’s therein, the payload bit inversion field may be set to ‘0’.

Hereinafter, a method for transmitting/receiving a covert channel packet in the above-described transmission apparatus 10 and reception apparatus 20 will be described.

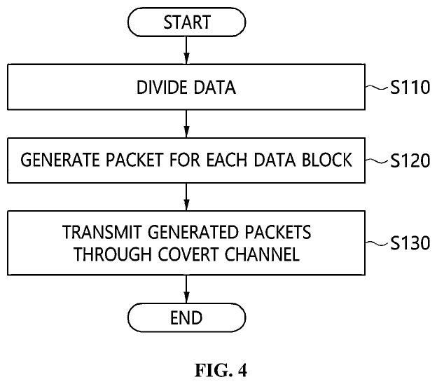

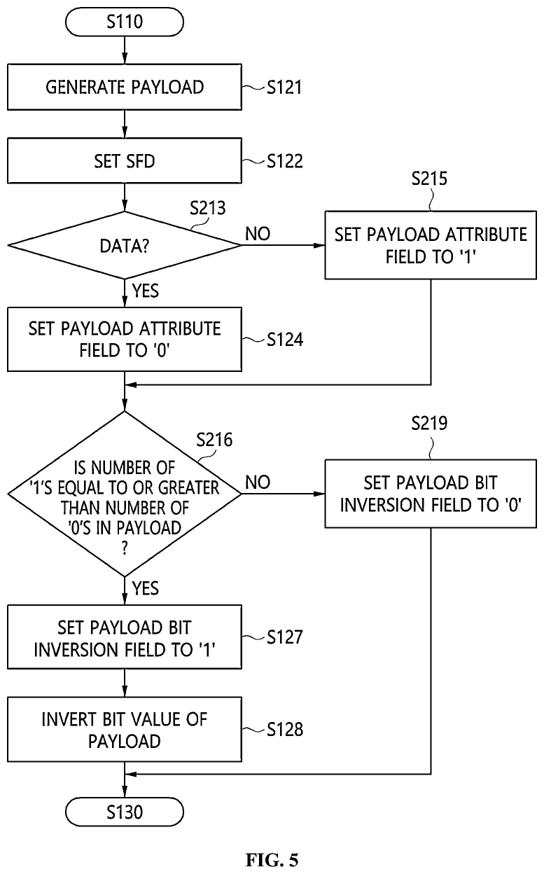

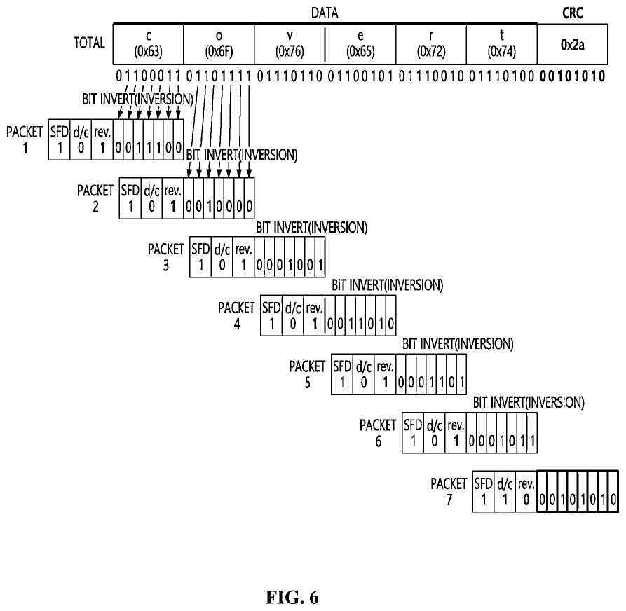

FIG. 4 is a flowchart for explaining a method for transmitting information using a wireless covert channel according to an embodiment, FIG. 5 is a flowchart for explaining a packet generation step according to an embodiment, and FIG. 6 is an exemplary view for explaining a method for transmitting information using a wireless covert channel according to an embodiment.

Referring to FIG. 4, the method for transmitting information using a wireless covert channel according to an embodiment may include dividing data into data blocks having a predetermined size at step S110, generating packets from the respective data blocks at step S120, and transmitting the generated packets through a covert channel at step S130.

For example, when the entire data to be transmitted is “covert”, as illustrated in FIG. 6, each of the characters of “covert” may be converted into an ASCII value and transmitted as an individual packet. That is, six bytes of character data are transmitted, and one byte of a CRC value may be transmitted. Therefore, a total of seven packets may be transmitted in order to transmit “covert”.

Generating the packets at step S120 according to an embodiment will be described in detail below with reference to FIG. 5 and FIG. 6.

First, the transmission apparatus 10 generates a payload at step S121. Here, when the payload is data such as c, o, v, e, r, or t, as illustrated in FIG. 6, the MSB is omitted, and the lower seven bits may be set to the ASCII code corresponding to the character.

However, when the payload is a CRC, all of the eight bits may be set to the CRC.

Subsequently, the transmission apparatus 10 may generate a packet by adding a header to the front of the payload containing the data or the CRC.

Here, the header may include a Start Frame Delimiter (SFD) field indicating the start point of the packet, a payload attribute field indicating whether the payload is data or a CRC, and a payload bit inversion field indicating whether the value of the payload is inverted in units of bits.

The transmission apparatus 10 sets the SFD of the header to ‘1’ at step S122. That is, the SFD is set to ‘1’ in all of packets 1 to 7, as shown in FIG. 6.

Subsequently, the transmission apparatus 10 determines whether the payload is data or CRC at step S123.

When it is determined at step S123 that the payload is data, the transmission apparatus 10 sets the payload attribute field to ‘0’ at step S124. For example, the second bit, which is the payload attribute field, in packet 1 for transmitting ‘c’ is set to ‘0’, as illustrated in FIG. 6.

Conversely, when it is determined at step S123 that the payload is a CRC, the transmission apparatus 10 sets the payload attribute field to ‘1’ at step S125. For example, the second bit, which is the payload attribute field, in packet 7 for transmitting a CRC is set to ‘1’, as illustrated in FIG. 6.

Subsequently, the transmission apparatus 10 determines whether the number of ‘1’s in the payload is equal to or greater than the number of ‘0’s therein at step S126.

When it is determined at step S126 that the number of ‘1’s is equal to or greater than the number of ‘0’s in the payload, the transmission apparatus 10 sets the payload bit inversion field to ‘1’ at step S127 and inverts the bit values of the payload at step S128.

For example, because the number of ‘1’s in the lower seven bits (“1100011”) of the ASCII value of the payload of packet 1 for transmitting ‘c’ is greater than the number of ‘0’s therein, as illustrated in FIG. 6, the payload bit inversion field may be set to ‘1’. Subsequently, the values of the lower seven bits of the payload, “1100011”, are inverted, whereby “0011100” may be contained in the payload.

Conversely, when it is determined at step S126 that the number of ‘1’s is less than the number of ‘0’s in the payload, the transmission apparatus 10 sets the payload bit inversion field to ‘0’ at step S129. For example, because the number of ‘1’s in the bit values “00101010” of the payload of packet 7 for transmitting a CRC is less than the number of ‘0’s therein, as illustrated in FIG. 6, the payload bit inversion field may be set to ‘0’.

According to the above-described embodiment, when a large amount of data cannot be transmitted at once due to poor communication conditions or states of a wireless covert channel, transmission packets may be formed by dividing the data into smallest units.

Here, when the communication state for the covert channel is poor, an analog signal, which is a received wireless signal, has very low intensity, and it may be difficult for the reception apparatus 20 to search for the start point of the packet signal.

Therefore, covert channel communication according to an embodiment may be performed at the time agreed upon in advance between the transmission apparatus 10 and the reception apparatus 20, rather than a random time. Nevertheless, in order to search for a digital value in the received analog signal with low intensity, a method for receiving information using a wireless covert channel according to an embodiment is proposed. The method for receiving information using a wireless covert channel according to an embodiment may be suitable for the poor communication states of the covert channel or the case in which the difference between the maximum and minimum values of the received signal is small because the transmitted signal has very low intensity in order to improve the concealment of the covert channel.

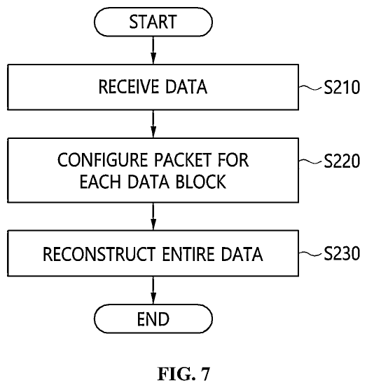

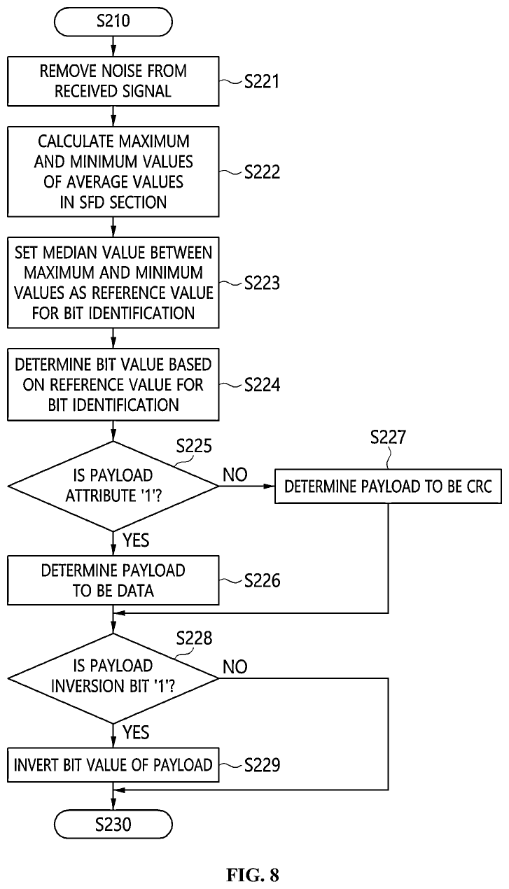

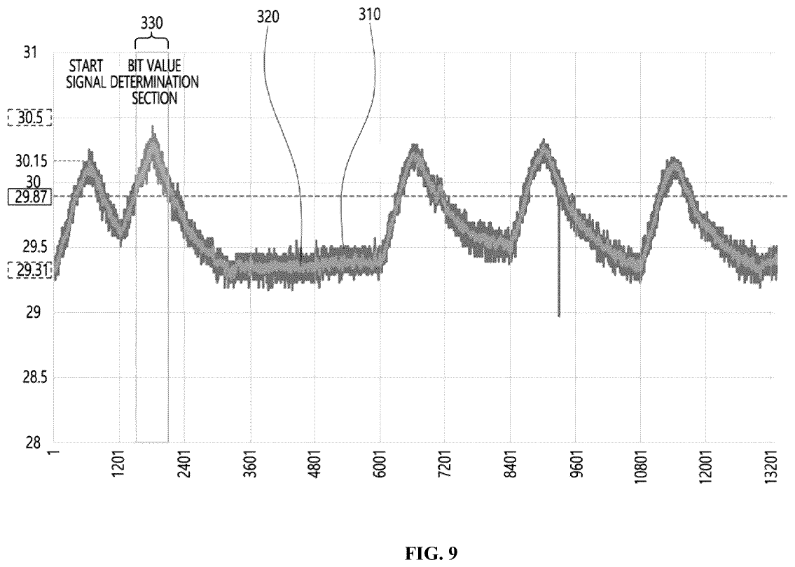

FIG. 7 is a flowchart for explaining a method for receiving information using a wireless covert channel according to an embodiment, FIG. 8 is a flowchart for explaining a packet configuration step according to an embodiment, and FIG. 9 is an exemplary view of a graph of a signal received using a covert channel according to an embodiment.

Referring to FIG. 7, the method for receiving information using a wireless covert channel according to an embodiment may include receiving data blocks having a predetermined size through a wireless covert channel at step S210, configuring a packet based on each of the data blocks at step S220, and reconstructing the entire data by combining the data blocks at step S230.

Configuring a packet based on each of the data blocks at step S220 according to an embodiment will be described in detail with reference to FIG. 8 and FIG. 9.

Referring to FIG. 8, the reception apparatus 20 may remove noise from analog data received through the wireless covert channel at step S221. For example, the raw data 310 of the received signal includes a lot of noise components, as illustrated in FIG. 9. In order to alleviate the noise components, average values for the previous 10 points are calculated at each point of the raw data 310 of each received signal. The 10 average values calculated in this way may be the graph denoted by the reference number 320 in FIG. 9.

Subsequently, the reception apparatus 20 determines a reference value for bit identification using a received signal in the section of a Start Frame Delimiter (SFD) field indicating the start point of a packet at steps S222 to S223.

That is, the bit value of the SFD of a packet is always ‘1’ in the embodiment. Therefore, the reference value for bit identification is determined using the section of the SFD field.

Here, determining the reference value for bit identification may include calculating the maximum and minimum values of the average values of a predetermined number of received signals in the section of the SFD field at step S222 and setting a predetermined median value between the calculated maximum and minimum values as the reference value for bit identification at step S223.

For example, the minimum and maximum values of the 10 average values in the section of the SFD field are calculated, and a point that is ⅔ of the way between the minimum and maximum values may be set as the reference value for bit identification. Referring to FIG. 9, the minimum value and maximum value of the 10 average values in the ‘start signal’ section are 29.31 and 30.15, respectively. Therefore, 29.87 at the point that is ⅔ of the way between the minimum and maximum values may be set as the reference value for bit identification.

Accordingly, the reception apparatus 20 determines bit values constituting the received packet using the received signal based on the reference value for bit identification at step S224.

Here, determining the bit values at step S224 may include determining whether received signals within a predetermined intermediate section in each bit reception period are equal to or greater than the reference value for bit identification and determining the bit value in the corresponding bit reception period to be ‘1’ or ‘0’ depending on whether the number of contiguous received signals equal to or greater than the reference value for bit identification is equal to or greater than a predetermined number.

Here, referring to FIG. 9, whether received signals in the bit value determination section 330 in the second bit reception period are equal to or greater than 29.87, which is the reference value for bit identification, is determined. That is, when the time taken to receive a single bit is 12, the bit value determination section 330 may be a range between 3 and 9.

Also, because the received signal in the bit value determination section 330 in the second bit reception period is equal to or greater than 29.87, which is the reference value for bit identification, the second bit may be ‘1’. Conversely, because the received signal in the bit value determination section in the third bit reception period is equal to or less than 29.87, which is the reference value for bit identification, the third bit may be ‘0’. Subsequently, the reception apparatus 20 determines whether the payload is data or a CRC at steps S225 to S227 depending on the value of the payload attribute field in the determined bit values. For example, referring to FIG. 9, because the payload attribute field, which is the second bit, is determined to be ‘1’, the received packet may be a CRC.

Subsequently, the reception apparatus 20 may invert the value of the payload in units of bits depending on the value of the payload bit inversion field in the determined bit values at steps S228 to S229.

For example, referring to FIG. 9, because the payload bit inversion field, which is the third bit, is determined to be ‘0’, the value of the payload is not inverted, and may be ‘00101010’, which is determined at step S224.

Accordingly, in the received signal illustrated in FIG. 9, the first bit is a start signal and is always ‘1’, the second bit is a payload attribute field and has a value of ‘1’, which indicates that the payload is a CRC, and the third bit is a payload bit inversion field and has a value of ‘0’, which indicates that the bit values of the payload are not inverted. Therefore, the fourth to eleventh bits indicate a CRC having a value of 00101010b, which is 0x2A as a hexadecimal value.

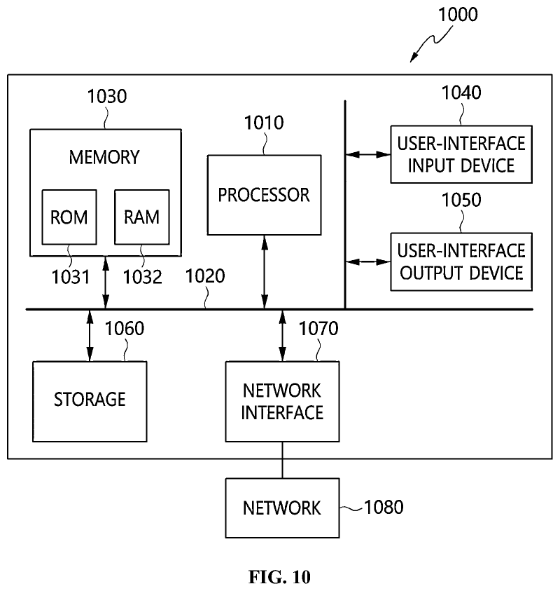

FIG. 10 is a view illustrating a computer system configuration according to an embodiment.

Each of the apparatus 10 for transmitting information using a wireless covert channel and the apparatus 20 for receiving information using a wireless covert channel according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, the intensity of a signal to be transmitted through a covert channel is reduced, whereby an increase in system load may be prevented.

The disclosed embodiment intends to minimize the frequency of generation of a signal to be transmitted through a covert channel in poor communication conditions or states.

That is, in covert channels using electromagnetic waves, magnetic fields, sound, or the like as well as covert channels using heat, which aggravate system load, a covert channel transmission packet structure according to an embodiment is effective when data cannot be transmitted at once and a message is transmitted in multiple segments through the covert channel due to the poor data delivery environment.

The disclosed embodiment intends to enable an agreed-upon receiver of a covert channel to easily identify a covert channel signal even when the frequency and intensity of the covert channel signal generated for delivering information are minimized. That is, an algorithm for determining a bit value based on an analog signal is effective as a method for obtaining information of the covert channel even in the poor communication state of the covert channel or in the state in which the intensity of the transmitted signal of the covert channel is very low because high confidentiality is required.

When it is not easy to identify a covert channel signal, the disclosed embodiment presents a method for solving this problem. Therefore, information can be delivered by significantly reducing the intensity and frequency of the covert channel signals, which makes it more difficult for a third party other than an agreed-upon receiver to identify the covert channel signal, whereby the concealment of the covert channel may be improved.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for transmitting information using a wireless covert channel, comprising:
memory in which at least one program is recorded; and
a processor for executing the program,
wherein:
the program generates a packet from each of data blocks having a predetermined size acquired by dividing data and transmits the packet through a covert channel,
the packet is configured with a header and a payload, and
the header includes a Start Frame Delimiter (SFD) field indicating a start point of the packet, a payload attribute field indicating whether the payload is data or a Cyclic Redundancy Check (CRC), and a payload bit inversion field indicating whether a value of the payload is inverted in units of bits.

2. The apparatus of claim 1, wherein the SFD field is one bit in length and is set to ‘1’.

3. The apparatus of claim 1, wherein:
the payload bit inversion field is one bit in length,
the payload bit inversion field is set to ‘1’ when a number of ‘1’s in bit values of the payload is equal to or greater than a number of ‘0’s therein, but is set to ‘0’ when the number of ‘1’s in the bit values of the payload is less than the number of ‘0’s therein, and
the bit values of the payload are inverted when the payload bit inversion field is set to ‘1’.

4. The apparatus of claim 1, wherein:
when the payload is one byte in length, the payload attribute field is one bit in length, and
the payload attribute field is set to ‘0’ when the payload is data, but is set to ‘1’ when the payload is a CRC.

5. The apparatus of claim 4, wherein:
when the payload is data, lower seven bits of the payload are set to an ASCII code corresponding to a character, whereas when the payload is a CRC, eight bits of the payload is set to the CRC.

6. The apparatus of claim 1, wherein:
when the payload is three bytes in length, the payload attribute field is two bits in length, and
the payload attribute field is set to ‘00’ when the payload is one-byte data, is set to ‘01’ when the payload is two-byte data, is set to ‘10’ when the payload is three-byte data, and is set to ‘11’ when the payload is a CRC.

7. An apparatus for receiving information using a wireless covert channel, comprising:
memory in which at least one program is recorded; and
a processor for executing the program,
wherein the program determines a reference value for bit identification using a received signal in a section of a Start Frame Delimiter (SFD) field indicating a start point of a packet, determines bit values constituting a received packet using a received signal based on the reference value for bit identification, determines whether a payload is data or a Cyclic Redundancy Check (CRC) depending on a value of a payload attribute field in the determined bit values, and inverts a value of the payload in units of bits depending on a value of a payload bit inversion field in the determined bit values.

8. The apparatus of claim 7, wherein, before determining the reference value for bit identification, the program calculates average values for a predetermined number of previous points at each point of received raw data.

9. The apparatus of claim 8, wherein, when determining the reference value for bit identification, the program calculates maximum and minimum values of average values of a predetermined number of received signals in the section of the SFD field and sets a predetermined median value between the calculated maximum and minimum values as the reference value for bit identification.

10. The apparatus of claim 8, wherein, when determining the bit values, the program determines whether received signals within a predetermined intermediate section in each bit reception period are equal to or greater than the reference value for bit identification and determines a bit value of the corresponding bit reception period to be ‘1’ or ‘0’ depending on whether a number of contiguous received signals equal to or greater than the reference value for bit identification is equal to or greater than a predetermined number.

11. A method for transmitting/receiving information using a wireless covert channel, comprising:
dividing, by a transmission apparatus, data into data blocks having a predetermined size;
generating, by the transmission apparatus, packets from the respective data blocks; and
transmitting, by the transmission apparatus, the generated packets through a covert channel,
wherein:
the packet is configured with a header and a payload, and
the header includes a Start Frame Delimiter (SFD) field indicating a start point of the packet, a payload attribute field indicating whether the payload is data or a Cyclic Redundancy Check (CRC), and a payload bit inversion field indicating whether a value of the payload is inverted in units of bits.

12. The method of claim 11, wherein the SFD field is one bit in length and is set to ‘1’.

13. The method of claim 11, wherein
the payload bit inversion field is one bit in length,
the payload bit inversion field is set to ‘1’ when a number of ‘1’s in bit values of the payload is equal to or greater than a number of ‘0’s therein, but is set to ‘0’ when the number of ‘1’s in the bit values of the payload is less than the number of ‘0’s therein, and
the bit values of the payload are inverted when the payload bit inversion field is set to ‘1’.

14. The method of claim 11, wherein:
when the payload is one byte in length, the payload attribute field is one bit in length, and
the payload attribute field is set to ‘0’ when the payload is data, but is set to ‘1’ when the payload is a CRC.

15. The method of claim 14, wherein, when the payload is data, lower seven bits of the payload are set to an ASCII code corresponding to a character, whereas when the payload is a CRC, eight bits of the payload is set to the CRC.

16. The method of claim 11, wherein:
when the payload is three bytes in length, the payload attribute field is two bits in length, and
the payload attribute field is set to ‘00’ when the payload is one-byte data, is set to ‘01’ when the payload is two-byte data, is set to ‘10’ when the payload is three-byte data, and is set to ‘11’ when the payload is a CRC.

17. The method of claim 11, further comprising:
determining, by a reception apparatus, a reference value for bit identification using a received signal in a section of the SFD field indicating the start point of the packet;
determining, by the reception apparatus, bit values constituting a received packet using a received signal based on the reference value for bit identification;
determining, by the reception apparatus, whether the payload is data or a CRC depending on a value of the payload attribute field in the determined bit values; and
inverting, by the reception apparatus, the value of the payload in units of bits depending on a value of the payload bit inversion field in the determined bit values.

18. The method of claim 17, further comprising:
before determining the reference value for bit identification, calculating average values for a predetermined number of previous points at each point of received raw data.

19. The method of claim 18, wherein determining the reference value for bit identification includes
calculating maximum and minimum values of average values of a predetermined number of received signals in the section of the SFD field; and
setting a predetermined median value between the calculated maximum and minimum values as the reference value for bit identification.

20. The method of claim 18, wherein determining the bit values includes
determining whether received signals within a predetermined intermediate section in each bit reception period are equal to or greater than the reference value for bit identification; and
determining a bit value in the corresponding bit reception period to be ‘1’ or ‘0’ depending on whether a number of contiguous received signals equal to or greater than the reference value for bit identification is equal to or greater than a predetermined number.
